(19) United States
(12) Patent Application Publication
(10) Pub. No.: US 2007/0038495 A1
(43) Pub. Date: Feb. 15, 2007

(54) Online web based organizer

(76) Inventor: Daniel J. Miner, Turlock, CA (US)

Correspondence Address: LAW OFFICE OF STEVEN B. LEAVITT, L.L.P., P.O. BOX 537, ROWLETT, TX, 75030-0537, US

(21) Appl. No.: 11/364,788

(22) Filed: Feb. 28, 2006

Related U.S. Application Data
(60) Provisional application No. 60/703,924, filed on Jul. 30, 2005.

(51) Int. Cl. G05B 19/418

(52) U.S. Cl. 705/8; 715/963

(57) ABSTRACT

The present invention allows users to create virtually any online list to store and sort data. Users can choose from pre-made templates for a specific organizer including, but not limited to, automobile, birthdays, bookmarks, computer information, contacts, critical information, emails, favorites, home information, lock combinations, lost wallet information, tracking on-line orders, pet information, restaurants, remote control codes, subscriptions, software install codes, taxes, warrantee tracking, and year in review information. By using a template, a new user can quickly and easily start entering data into the organizer and an existing user can quickly and easily create a new organizer. An unlimited number of templates can be added within the system for all users to choose from and as new ideas for organizers are discovered, a template can be created.

This application claims the benefit of U.S. Provisional Application No. 60/703,924, filed Jul. 30, 2005, which is incorporated herein by reference.

### BACKGROUND OF THE INVENTION

1. Technical Field

This invention relates to organizers, and more particularly, to online web based organizers containing customizable lists with various types of column data.

2. Description of Related Art

As people become busier, a system to keep all their contacts, to-do lists, schedules, and other information in an easily accessible place becomes desirable. The need to keep important information easily accessible resulted in the creation of organizers. Typically, an organizer is a device that includes a calendar, space to write “to-do” lists, and space to write telephone numbers, addresses, and other basic identifying/reference information. It can be a paper-and-pencil model, an electronic organizer such as a PDA, or it can be time management software on a laptop or desktop computer.

While the paper-and-pencil has been the most popular, there are several disadvantages. For example, the paper-and-pencil models typically have A-Z tabs and users often run out of room in A-Z tabs to write names, addresses, and phone numbers. Also, contact information must be rewritten when people move, no security or password is required to access the organizer, some organizers can be large and bulky while smaller versions often don't have enough writing surface and calendar space, and the organizers are often overflowing with assorted papers and sticky notes. In addition, paper-and-pencil models can be lost, stolen, destroyed, or damaged beyond readability. Electronic organizers have a number of advantages over the paper-an-pencil mode.

For example, electronic organizers such as PDA's can provide audible reminders that serve as memory management aides, they can sort, organize, and store more information more efficiently than paper and pencil planners. Further, the to-do lists do not have to be re-written and will often roll forward automatically. PDA's also have a search capability to find to-do tasks and contact, hold thousands of contact names and numbers, can easily exchange information with office and home computers, and the organizer can be easily shared. However, an electronic organizer can be easily lost, stolen, or damaged often resulting in a complete loss of all the information stored on the electronic organizer. Also, the electronic organizer can be forgotten rendering the information in the organizer inaccessible.

Because of the above limitations, more and more users have time management software on a laptop or desktop computer. However, some of the limitations of the electronic organizer are present when using time management software on a laptop or desktop computer. For example the computer can be stolen or damaged resulting in a complete loss of all the information stored on the computer. Also, the computer where the organizer is located can be forgotten or not easily accessed rendering the information in the organizer inaccessible. To address the above limitations, organizers hosted on a server have been created. The organizers are accessed via the Internet, LAN, WAN, or some other similar means for connecting to the hosting server.

Because the organizer is hosted on a server, there is little chance the device storing the organizer can be lost, stolen, or damaged resulting in a complete loss of all information in the organizer. In addition, if the organizer is accessed via the Internet, the only device needed to access the information is a computer and an Internet connection. However, online organizers are not very user friendly and are inflexible. A user wanting to use an online organizer cannot easily modify the organizer to customize it. Also, many of the organizers do not have templates for storing or organizing important data such as automobile maintenance or mileage information, birthdays, bookmarks with associated usernames and password hints, contact lists, computer information, emails, home information, lock combinations, lost wallet information, tracking on-line orders, pet information, list and comments on restaurants, remote control codes, subscriptions, software information, taxes, and year in review information.

Therefore, what is needed is an online organizer that can be easily customized and is flexible so as to fit a specific user's unique needs.

### SUMMARY OF THE INVENTION

The organizer of the present invention solves the above-described problem by providing a web based service that allows users to create dynamic tables, called organizers wherein the user can customize the columns in the organizer.

The present invention allows users to create virtually any online list to store and sort data. Users can choose from pre-made templates for a specific organizer including, but not limited to, automobile, birthdays, bookmarks, computer information, contacts, critical information, emails, favorites, home information, lock combinations, lost wallet information, tracking on-line orders, pet information, restaurants, remote control codes, subscriptions, software install codes, taxes, warrantee tracking, and year in review information. By using a template, a new user can quickly and easily start entering data into the organizer and an existing user can quickly and easily create a new organizer. An unlimited number of templates can be added within the system for all users to choose from and as new ideas for organizers are discovered, a template can be created.

In addition, users can take existing templates and modify them to suit their needs. For example, a user can add, remove, and rename columns, change the name of the organizer, move the order of the columns, or even create their own organizers from scratch. Also, users can sort their organizer by column (ascending and descending), associate specific types of data with each column, including but not limited to relatively short text, relatively long text long, date, hyperlink, email link, phone number, boolean, currency, or file link. Users can share their organizers with other users with read-only, write, or full control permissions and can group their organizers into folders.

The present system is accessed over the Internet and no download is ever needed. The data is encrypted via https WebPages and therefore is secure. Alerts are also incorporated into every organizer on a per entry basis and can be displayed on the user's home page. The alerts can be displayed and/or emailed to a single or multiple addresses at a predetermined date and time on a per alert basis or row/entry bases. For example in a birthday organizer, for one birthday reminder, the reminder can be sent five days before the actual birthday whereas for a second birthday reminder, the reminder may be sent ten days before the actual birthday. This can be done for any reminder entry in any organizer within the system.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein

FIG. 1 is a flow chart of one embodiment of the present invention;

FIG. 2 is a flow chart of one embodiment of the present invention;

FIG. 3 is a flow chart of one embodiment of the present invention;

FIG. 4 is a flow chart of one embodiment of the present invention;

FIG. 5 is a flow chart of one embodiment of the present invention;

FIG. 6 is a flow chart of one embodiment of the present invention;

FIG. 7 is a flow chart of one embodiment of the present invention;

FIG. 8 is a flow chart of one embodiment of the present invention;

FIG. 9 is a screen shot of an embodiment of the present invention;

FIG. 10 is a flow chart of one embodiment of the present invention; and

FIG. 11 is a screen shot of an embodiment of the present invention.

### DETAILED DESCRIPTION

In the following detailed description, reference is made to the accompanying drawings that form a part hereof, and in which is shown by way of illustration, specific embodiments in which the invention may be practiced. These embodiments ate described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

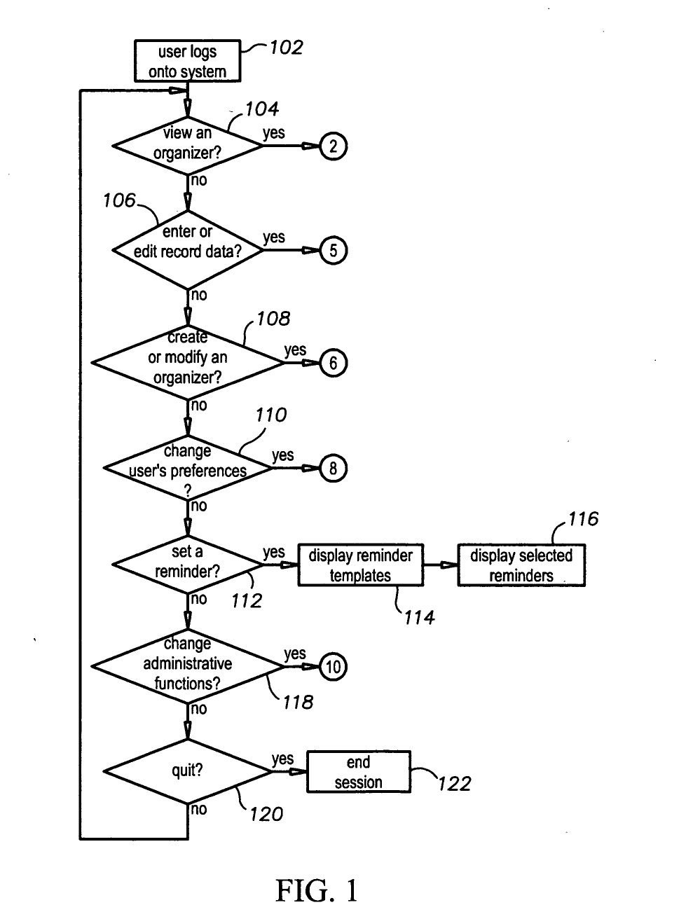

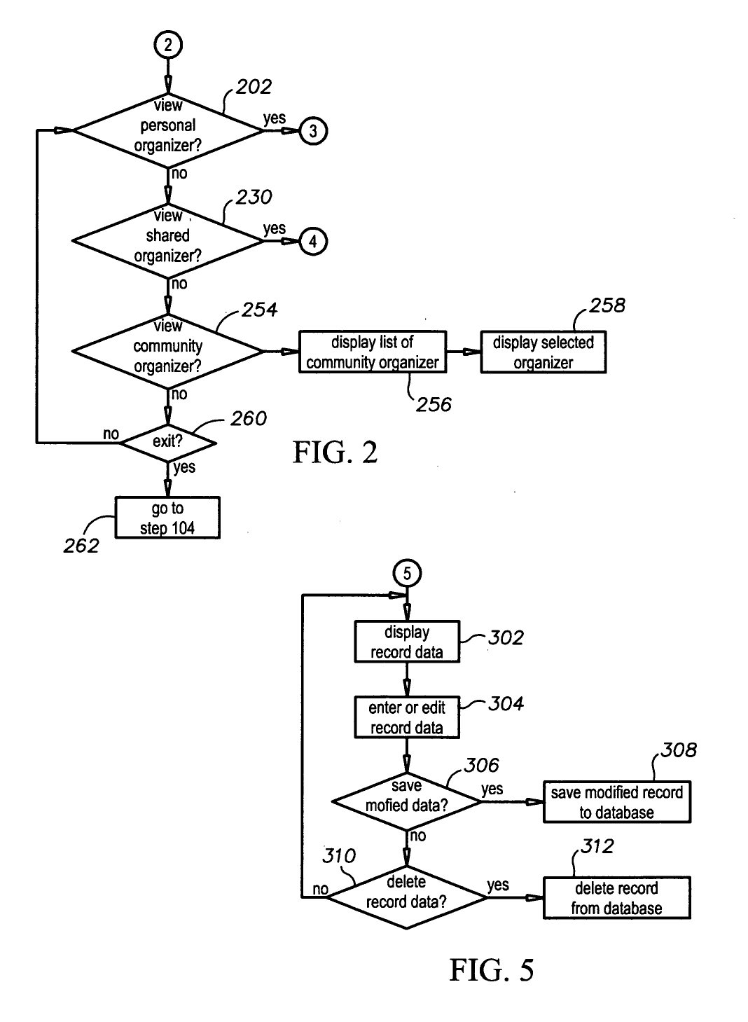

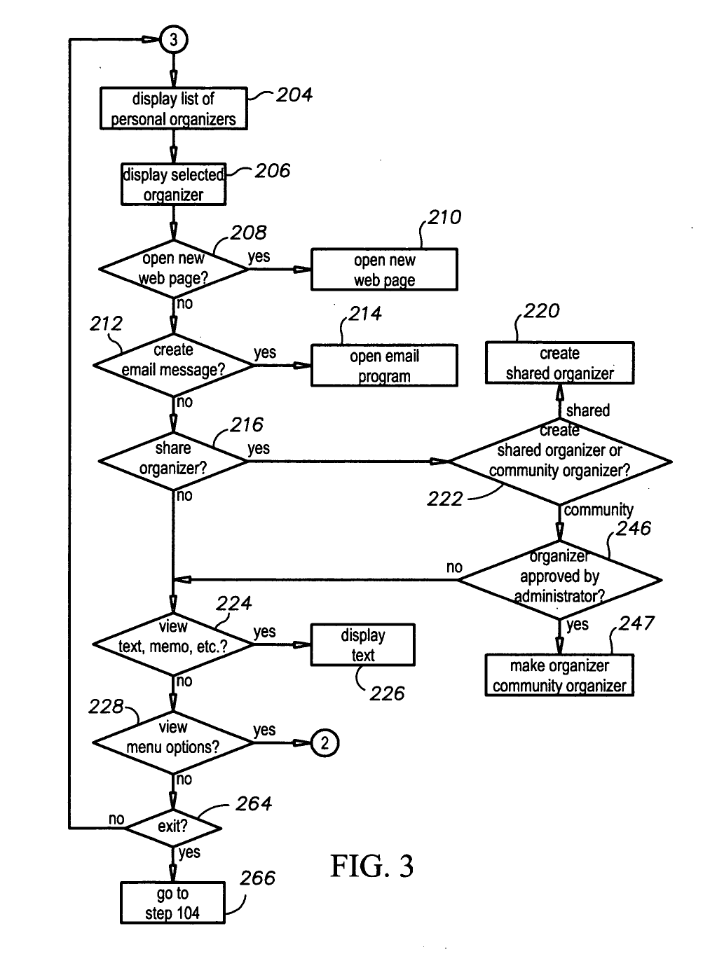

The first step, as shown in FIG. 1, a user logs on or the system is accessed, Step 102. Then the system determines if the user wants to view organizers, Step 104. If the system determines the user wants to view an organizer, then the system determines if the user wants to view a personal organizer, Step 202, FIG. 2. If the system determines the user wants to view a personal organizer, the system displays a list of personal organizers that the user can view, Step 204, FIG. 3. Then the system determines which personal organizer the user wants to view and that organizer is displayed, Step 206. Next, the system determines if the user wants to, open a new web site page, Step 208. If the system determines that the user wants to open a new web site page, then the system opens a new web site page via the default web browser, Step 210. If the user does not want to open a new web page, then the system determines if the user wants to create an e-mail message, Step 212.

If the user wants to create an e-mail message, then the system opens the default e-mail program on the user's computer so the user can create an e-mail, Step 214. If the user does not want to create an e-mail message, then the system determines if the user wants to share the organizer with others, Step 216.

If the system determines that the user wants to share the organizer with others, then the system determines if the user wants to make the organizer a shared organizer or a community organizer, Step 218. If the user wants to make the organizer a shared organizer, then the system makes the organizer a shared organizer, Step 220 and proceeds to Step 224 described below. If the system determines the user wants to make the organizer a community organizer, then the system determines if the administrator will allow the organizer to become a community organizer, Step 222. If the administrator will allow the organizer to become a community organizer, then the system makes the organizer a community organizer, Step 223. If the system determines that the administrator does not want the organizer to be a community organizer, then the system does not make organizer a community organizer and proceeds to Step 224 described below. If the system determines the user does not want to share the organizer, then the system determines if the user wants to view any texts, memos, messages, video, audio clips, or other items associated with the organizer, Step 224.

If the system determines the user wants to view any texts, memos, messages, video, audio clips, or other items associated with the organizer, then the system displays the selected texts, memos, messages, video, audio clips, or other items associated with the organizer, Step 226. If the system determines the user does not want to view any shared items associated with the organizer, then the system determines if the user wants to view the menu options, Step 228.

If the system determines the user does not want to view the menu options, then the system continues to display the organizer, repeats the above described steps starting with determining if the user wants to open a new page, Step 208. If the system determines the user wants to view the menu options, then the system returns the user to Step 202, FIG. 2, and determines if the user wants to view a personal organizer.

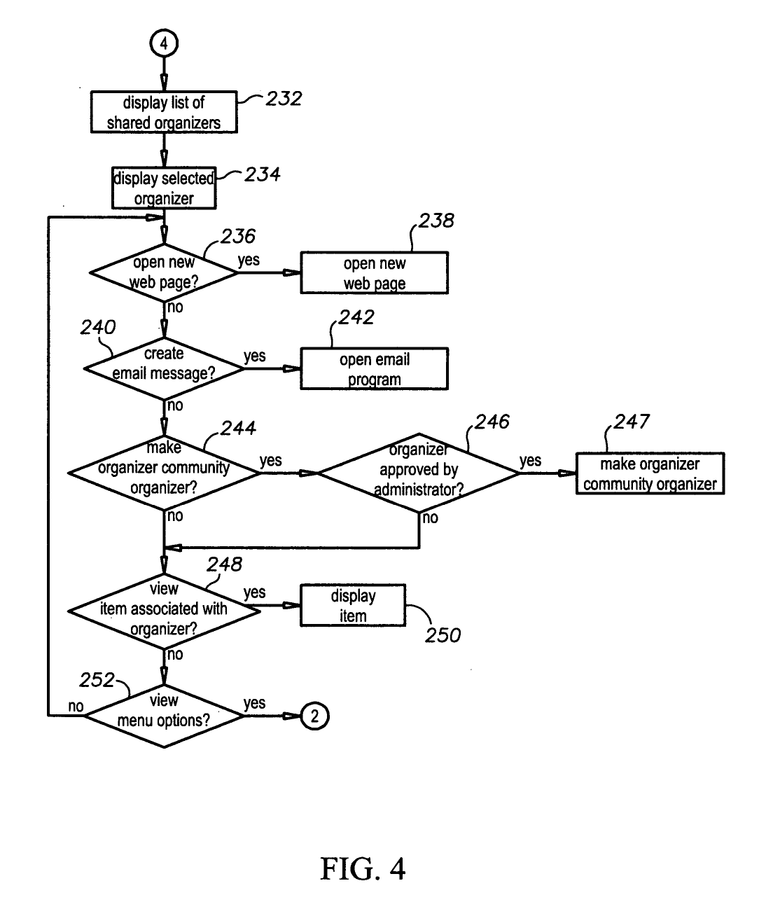

If the user does not want to view a personal organizer, then the system determines if the user wants to view a shared organizer, Step 230. If the system determines the user wants to view a shared organizer, then the system displays a list of shared organizers that the user can view, Step 232, FIG. 4. Then the system determines which shared organizer the user wants to view and that organizer is displayed, Step 234. Next, the system determines if the user wants to open a new page, Step 236. If the system determines that the user wants to open a new web site page, then the system opens a new web site page via the default web browser, Step 328. If the user does not want to open a new web page, then the system determines if the user wants to create an e-mail message, Step 240.

If the user wants to create an e-mail message, then the system opens the default e-mail program on the user's computer so the user can create an e-mail, Step 242. If the user does not want to create an e-mail message, then the system determines if the user wants to share the organizer with others and make the organizer a community organizer, Step 244.

If the system determines that the user wants to make the organizer a community organizer, then the system determines if the administrator will allow the organizer to become a community organizer, Step 246. If the administrator will allow the organizer to become a community organizer, then the system makes the organizer a community organizer, Step 247. If the system determines that the administrator does not want the organizer to be a community organizer, then the system does not make organizer a community organizer and proceeds to Step 248 described below. If the system determines the user does not want to share the organizer, then the system determines if the user wants to view any texts, memos, messages, video, audio clips, or other items associated with the organizer, Step 248.

If the system determines the user wants to view any texts, memos, messages, video, audio clips, or other items associated with the organizer, then the system displays the selected texts, memos, messages, video, audio clips, or other items associated with the organizer, Step 250. If the system determines the user does not want to view any shared items associated with the organizer, then the system determines if the user wants to view the view organizer menu options, Step 252.

If the system determines the user does not want to view the view organizer menu options, then the system continues to display the shared organizer, repeats the above described steps starting with determining if the user wants to open a new page, Step 236. If the system determines the user wants to view the view organizer menu options, then the system returns the user to Step 202, FIG. 2 and determines if the user wants to view a personal organizer.

If the user does not want to view a personal organizer, then the system determines if the user wants to view a shared organizer, Step 230. If the system determines the user does not want to view a shared organizer, then the system determines if the user wants to view a community organizer, Step 254. If the system determines the user wants to view a community organizer, then the system displays a list of community organizers that the user can view, Step 256. Then the system determines which community organizer the user wants to view and that organizer is displayed, Step 258.

If the system determines the user does not want to view the community organizer, then the system determines if the user wants to view organizers, Step 104, FIG. 1. If the system determines the user wants to view an organizer, then, as described above, the system determines if the user wants to view a personal organizer, Step 202, FIG. 2. If the system determines the user does not want to view an organizer, then the system determines if the user wants to edit record data, Step 106, FIG. 1.

If the system determines that the user wants to edit record data, then the system displays record data that the user can edit, Step 302. Next, the system allows the user to enter or modify record data, Step 304. After the user has entered or modified record data, the system determines if the user wants to save the entered or modified record data, Step 306. If the system determines the user wants to save the entered or modified record data, then the system saves the entered or modified record data to the system's database, Step 308, and the system returns to Step 106, FIG. 1.

If the system determines that the user does not want to save the record data, then the system determines if the user wants to delete the record, Step 310. If the system determines that the user does not want to delete the record data, then the system allows the user to enter or modify record data, Step 304. If the user wants to delete the record, then the system deletes the record from the system's database, Step 312, and the system returns to Step 106, FIG. 1 where the system determines if the user wants to edit record data.

If the system determines that the user wants to edit record data, then, as described above, the system displays record data that the user can edit, Step 302. If the system determines the user does not want to edit record data, then the system determines if the user wants to create or modify an organizer, Step 108.

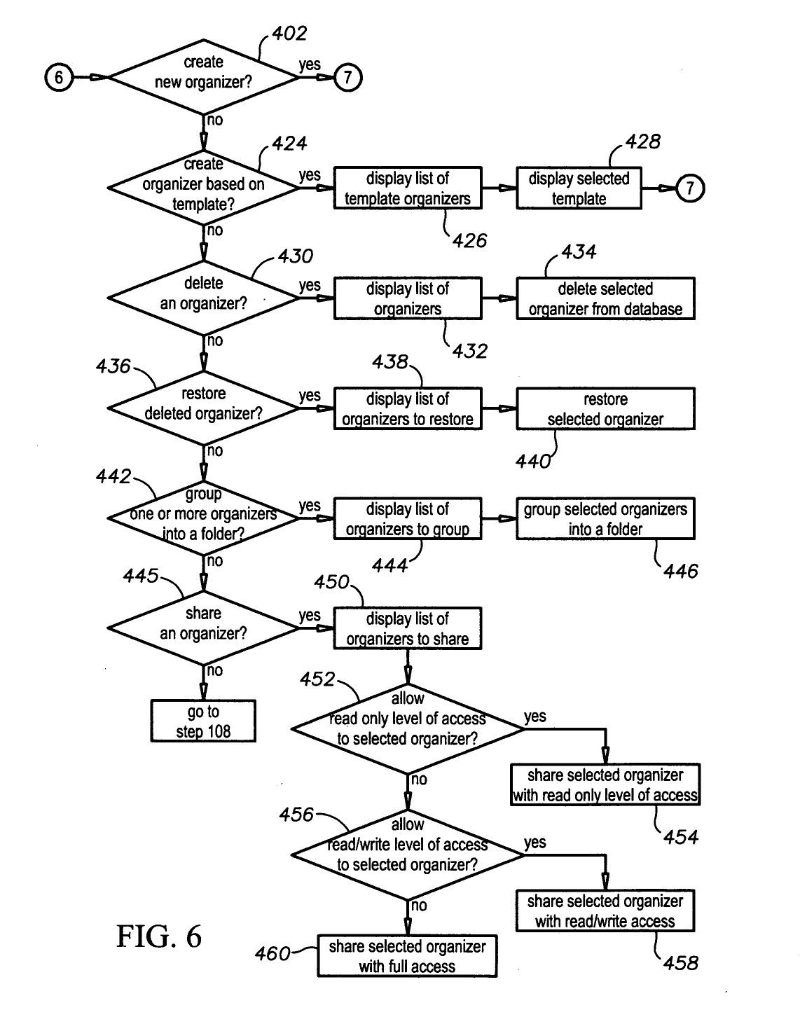

If the system determines the user wants to create or modify an organizer, then the system determines if the user wants to create a new organizer, Step 402, FIG. 6. If the system determines the user wants to create a new organizer, then the system allows the user to name the organizer, Step 404, name a column, Step 406, choose a type of data associated with the column, Step 408, set the order of the columns if there is more than one column, Step 410, delete a column, Step 412, or rename the organizer, Step 414.

Next, the system determines if the user wants to save the entered or modified data, Step 416. If the system determines the user wants to save the entered or modified record data, then the system saves the entered or modified record data to the system's database, Step 418.

If the system determines that the user does not want to save the record data, then the system determines if the user wants to create a new organizer, Step 402. If the system determines that the user wants to create a new organizer, then, as described above, the system allows the user to name the organizer, Step 404. If the system determines that the user does not want to create a new organizer, then the system determines if the user wants to create an organizer based on a template, Step 424.

If the system determines that the user wants to create an organizer based on a template, then the system displays a list of template that the user can select to create an organizer, Step 426. After the user selects a template to create an organizer, the system displays the selected template, Step 428 and then the system allows the user to name the organizer, Step 404, name a column, Step 406, choose a type of data associated with the column, Step 408, set the order of the columns if there is more than one column, Step 410, delete a column, Step 412, or rename the organizer, Step 414.

Next, the system determines if the user wants to save the entered or modified data, Step 416. If the system determines the user wants to save the entered or modified data, then the system saves the entered or modified data to the system's database, Step 418.

If the system determines that the user does not want to save the record data, then the system determines if the user wants to create a new organizer, Step 402. If the system determines that the user does not want to create a new organizer, then the system determines if the user wants to create an organizer based on a template, Step 424. If the system determines that the user does not want to create an organizer based on template, then the system determines if the user wants to delete an organizer, Step 430.

If the system determines the user wants to delete an organizer, then the system displays a list of organizers the user can delete, Step 432. After the user has selected what organizer to delete, then the system deletes the organizer from the system's database, Step 434. If the system determines that the user does not want to delete an organizer, then the system determines if the user wants to restore a deleted organizer, Step 436.

If the system determines that the user wants to restore a deleted organizer, then the system displays a list of organizers the user can restore, Step 438. After the user has selected what organizer to restore, then the system restores the organizer to the system's database, Step 440. If the system determines that the user does not want to restore a deleted organizer, then the system determines if the user wants to group one or more organizers into a folder, Step 442.

If the system determines the user wants to group one or more organizers into a folder, then the system displays a list of organizers the user can group into a folder, Step 444. After the user has selected what organizers to group into a folder, the system groups the organizers into a folder, Step 446. If the system determines the user does not want to group one or more organizers into a folder, then the system determines if the user wants to share an organizer, Step 448.

If the system determines the user wants to share an organizer, then the system displays a list of organizers the user can share, Step 450. After the user has selected what organizer to share, the system determines if the organizer will be shared with read only level of access, Step 452. If the system determines the user wants to share the organizer with read only level access, then the system allows others to have read only level access to the organizer. Step 454. Read only level access means that others can only read the organizer and cannot write to or delete the organizer.

If the system determines the user does not want to share the organize with read only access, then the system determines if the user wants to allow read/write level access to the organizer, Step 456. If the system determines the user wants to share the organizer with read/write level access, then the system allows others to have read/write level access to the organizer, Step 458. Read/write level access means that others can read and write to the organizer but cannot delete the organizer. If the system determines the user does not want to share the organizer with read/write access, then the system allows others to have full access to the organizer, Step 460. Full access to the organizer means others can read, write to, and delete the organizer. In another embodiment the user may select different levels of access for different people. For example, one person may have full access, a third person may have only read/write access, while a third and fourth person may have only read access.

If the system determines the user does not want to share an organizer, Step 448, then the system determines if the user wants to create or modify an organizer, Step 108. If the system determines the user wants to create or modify an organizer, then, as described above, the system determines if the user wants to create a new organizer, Step 402. If the system determines the user does not want to create or modify an organizer, then the system determines if the user wants to change the user's preferences, Step 110.

If the user wants to change the user's preferences, then the system determines if the user wants to change the organizers that are displayed after the user logs into the system, Step 502. If the user wants to change the organizers that are displayed, then the system displays a list of organizers that can be displayed when the user logs in, Step 504. After the user selects what organizers will be displayed upon login, the system modifies the organizers in the system's database so they will be displayed when the user logs onto the system, Step 506. If the user does not want to change the organizers that are displayed, then the system determines if the user wants to change the login password, Step 508.

If the user wants change the login password, then the system displays a text box where the user can enter a new password, Step 510. After the user has entered a new password, then the system saves the new password to the system's database, Step 512. If the system determines the user does not want to change the login password, then the system determines if the user wants to change any user information, Step 514. The user information may include but is not limited to name, address, e-mail, or phone number.

If the system determines the user wants to change any user information, then the system displays all the user information that can be changed, Step 516. After the user has changed the information, the system saves the entered or modified data to the system's database, Step 520. If the user does not want to change any user information, then the system determines if the user wants change the overall theme, Step 522. A theme is a preset package containing graphical appearance details, used to customize the look and feel of the system and/or display.

If the system determines the user wants to change a theme, then the system displays all themes the user may select, Step 524. After the user has selected a theme, the system stores the theme in the system's database, Step 526, and displays the theme whenever the user logs on.

If the system determines the user does not want to change a theme, then the system determines if the user wants to set a reminder, Step 112. If the system determines the user wants to set a reminder then the system displays a list of template reminders, Step 114. Next, the system determines what template the user wants to use to set a reminder and displays that reminder, Step 116. The template reminders can include, but are not limited to, birthday reminders, personal appointments, work appointments, anniversaries, bill payment dates, meeting dates, and travel dates. If the user wants to set an appointment and there is not a template, then the user can select a miscellaneous template from the displayed list.

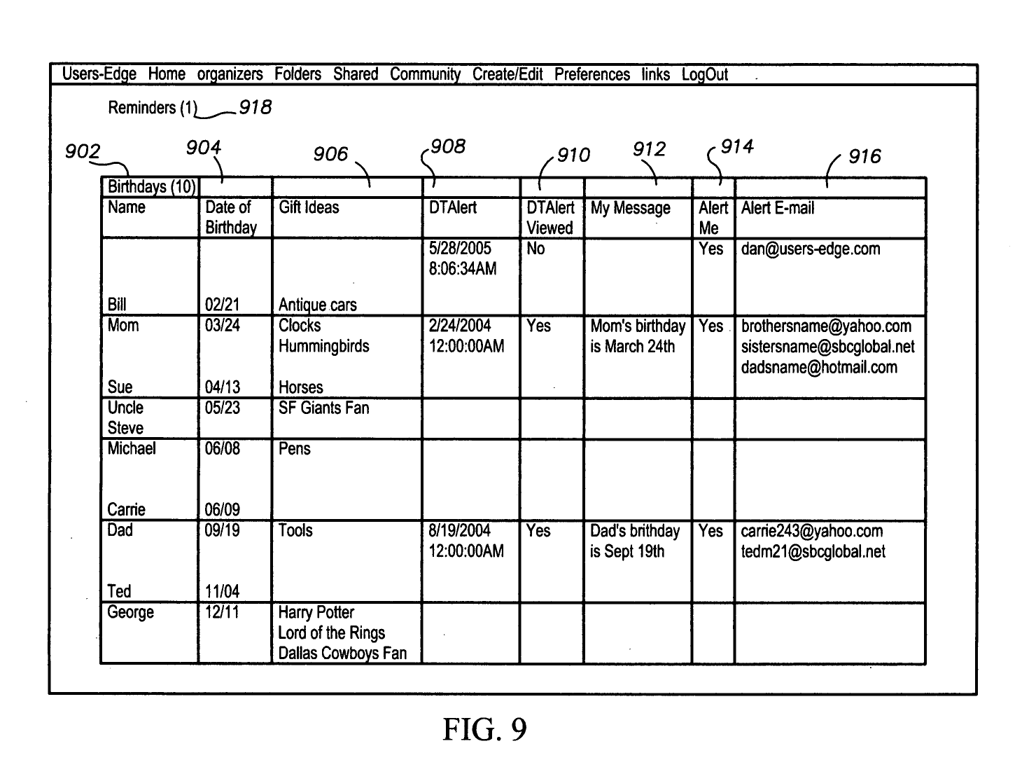

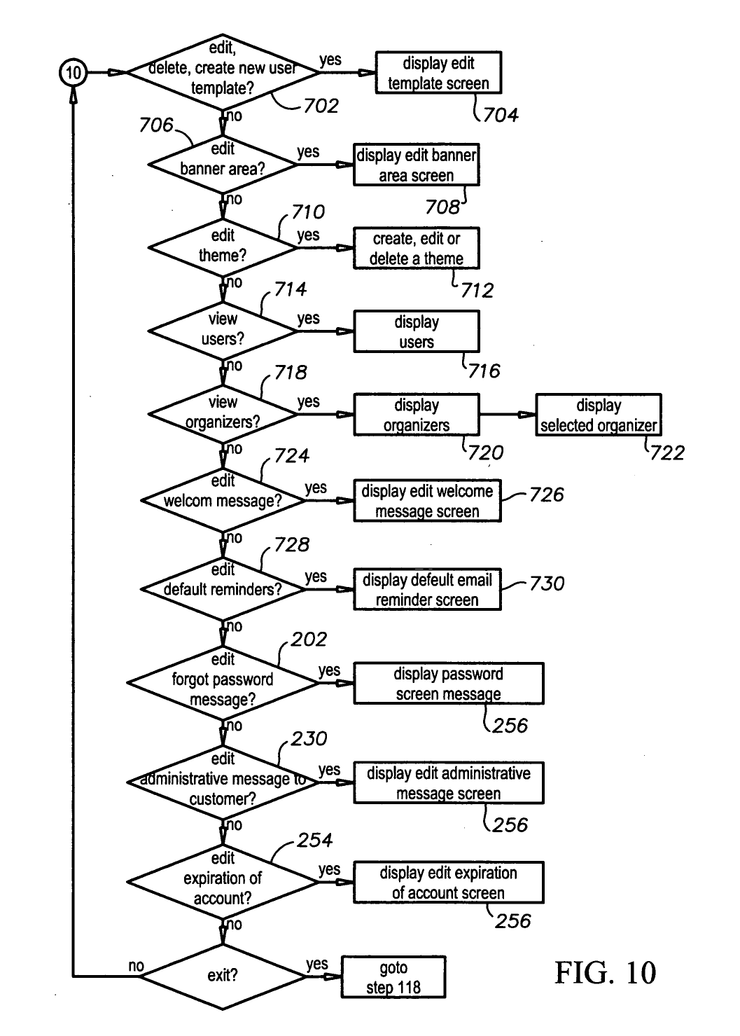

After the system determines what template the user want to use to set a reminder, the system displays a screen similar to that shown in FIG. 9. FIG. 9 depicts what is displayed when the system determines the birthday template is selected. FIG. 9 displays columns relevant to a birthday reminder. The columns include, but are not limited to name column 902, date of birthday column 904, gift ideas column 906, DTAlert column 908, alert viewed column 910, my message column 912, alert me column 914, and alert e-mail column 916.

Name column 902 displays the name of the person associated with the birthday. Date of birthday column 904 displays the birthday date of the person in name column 902. Gift ideas column 906 displays any gift ideas for the person in name column 902. Name column 902, date of birthday column 904, and gift ideas column 906 are unique to the birthday reminder template and may or may not be found in other reminder templates. DTAlert column 908, alert viewed column 910, my message column 912, alert me column 914, and alert e-mail column 916 are standard columns and found on every template. The order of the columns can be re-arranged and any column, including the standard columns, can be deleted or added.

DTAlert column 908 displays the date and time of when the alarm to remind the user is activated and/or a reminder e-mail is sent To set the date and time of the alarm, the user types in the desired date and time into DTAlert column 908. Alert viewed column 910 displays whether or not the alarm has been viewed. If the alarm has not been viewed, then the alarm is activated and/or a reminder e-mail is sent on the date and time in DTAlert column 908. If the alert has been viewed, then the alarm is not activated and/or the reminder e-mail is not sent on the date and time in DTAlert column 908. A user views an alert via reminder link 918 as shown in FIG. 9. Reminder link 918 is on all pages displayed by the system and lists any reminders in the system. If the reminder link 918 is selected, all active reminders in the system are view and they system allows the user to edit, delay, cause to reoccur, or dismiss any displayed reminders. The system allows the user to select how long the reminder will be delayed or when the reminder will reoccur and allows-the reminder to be delayed for or reoccur after a specific time period or the user can set an exact date for the reminder to reoccur. The method for editing a reminder is similar to the procedure for editing a record as shown in Step 106, FIG. 1.

My message column 912 displays the message that is sent in the e-mail when the alarm is activated and/or the reminder e-mail is sent on the date and time in DTAlert column 908, alert e-mail column 916 displays the e-mail address where the reminder is sent. The e-mail address can be the user's e-mail address or anybody else that the user wants to sent the alert.

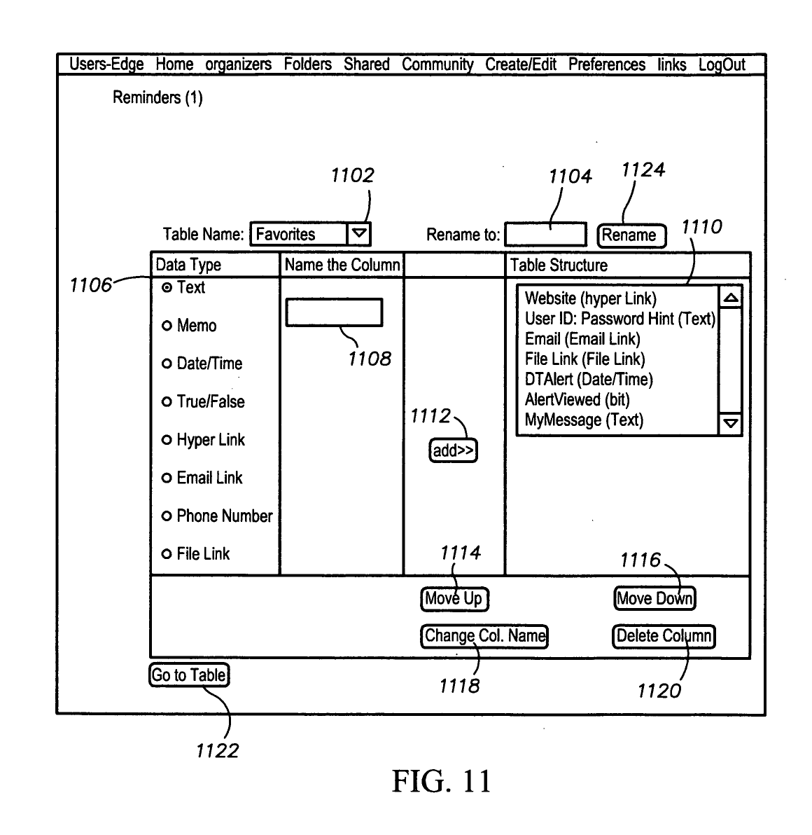

If in Step 112, FIG. 1, the system determines the user does not want to set a reminder, then the system determines if the user has the authority and wants to change the administrative functions of the system, Step 118. If the system determines the user has the authority and wants to changes the administrative functions of the system, then the system determines if the user wants to create a new organizer template, edit and existing organizer template, or delete an organizer template Step 702. If the system determines the user wants to create, edit or delete an organizer template, then the system displays an organizer edit screen similar to the one shown in FIG. 11 described in detail below, Step 704.

FIG. 11 shows table name text box 1102, rename text box 1104, data type selection list 1106, column name text box 1108, table structure box 1110, add button 1112, move up button 1114, move down button 1116, change column name button 1118, delete column button 1120, and go to table button 1122. Table name text box 1102 allows the user to type in a name for the organizer template. If the organizer template already has a name, it will appear in table name text box 1102.

Rename text box 1104 allows the user to change the name of the organizer. To change the name of the organizer, the new name is typed into rename text box 1104 and rename button 1124 is selected. Upon selection of rename button 1124, the text in rename text box 1104 is saved in the system's database as the displayed organizer template's name and is then displayed in table name text box 1102.

Data type selection list 1106 allows the user to define the data type that will be entered into a specific column. The type of data that may be entered into a specific column may include, but is not limited to, text, memo, date/time, true/false or boolean, hyperlink, e-mail link, phone number, hyperlink, or file link. By formatting each column to a specific data type, the organizer will appear uniform and mistakes by a user entering data can be reduced. For example, sometimes users do not enter enough numbers for a valid phone number. By formatting a column to accept only numbers with the format ###-###-####, the system can at least verify the correct amount of numbers have been entered.

Column name text box 1108 allows the user to enter the name of the column being created. After the data type for the column has been selected and the name of the column has been entered into column name text box 1108, add button 1112 is selected.

After add button 1112 is selected, the new column appears in table structure box 1110. Table structure box 1110 displays the order each column will be displayed in the template or organizer as well as the name and data type of each column. If the order of the columns is to be changed, a specific column may be selected and move up button 1114 may be selected to move the selected column up in the list of columns. Similarly, move down button 1116 may be selected to move the selected column down in the list of columns.

Change column name button 1118 allows the user to change a selected column's name or data type. When a specific column is selected and then change column name button 1118 is selected, the selected column's name is displayed in column name text box 1108 and the column type is displayed and highlighted in data type selection list 1106. Then the system allows the user to change the data type and name as described above. After the data type for the column has been changed and/or the name of the column has been changed, add button 1112 is selected and the changed column appears in table structure box 1110.

Delete column button 1120 allows a user to delete a selected column and go to table button 1122 causes the system to display the template or organizer that was created.

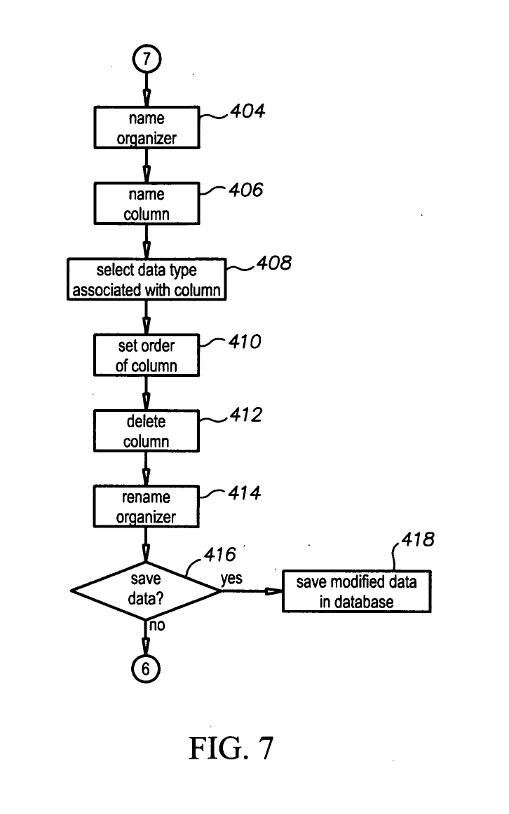

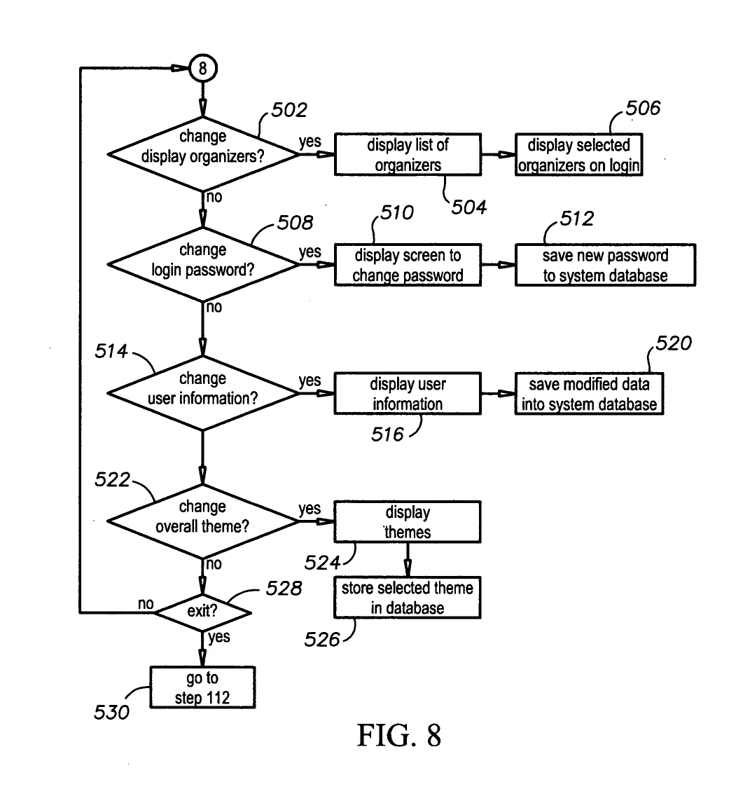

If the system determines the user does not want to create, edit, or delete a template, then the system determines the user wants to edit the banner area, Step 706, FIG. 7. If the system determines the user wants to edit the banner area, then the system displays the banner area and allows the user to edit the banner area, Step 708. If the system determines the user does not want to the banner area, then the system determines the user wants to create or edit a theme, Step 710. A theme is a preset package containing graphical appearance details, used to customize the look and feel of the system and/or display.

If the system determines the user wants to create or edit a theme, then the system allows the user to create or edit graphical appearance details, used to customize the look and feel of the system and/or display, Step 712. If the system determines the user does not want to edit a theme, then the system determines if the user wants to view a list of users registered with the system, Step 714.

If the system determines the user wants to view a list of users registered with they system, then the system displays a list of all the users registered with the system, Step 716. The list may include such details as when the user registered with the system and if each specific user is currently logged onto the system. If the system determines the user does not want to view a list of users registered with the system, then the system determines if the user wants to view any organizers, Step 718.

If the system determines the user wants to view an organizer, then the system displays a list of all the organizers in the system, Step 720. The system then determines what organizer or organizers the user selects and displays the selected organizers, Step 722. If the system determines the user does not want to view an organizer, then the system determines if the user wants to edit a welcome message that is displayed when a user first logs on Step 724.

If the system determines the user wants to edit the welcome message, then the system displays a screen where the user can edit the welcome message, Step 726. If the system determines the user does not want to edit the welcome message, then the system determines if the user wants to edit the default reminder e-mail notification, Step 728.

The default reminder e-mail notification is the default e-mail message that is sent when a reminder is activated. Examples, of reminder e-mail notifications are found in alert e-mail column 916 FIG. 9. If the system determines the user wants to edit the default reminder e-mail notification, then the system displays a screen where the user can edit the default reminder e-mail notification, Step 730. If the system determines the user does not want to edit the default reminder e-mail notification, then the system determines if the user wants to edit the forgot password message, Step 732.

The forgot password message is the message that is sent to a user when they request a new password because they have forgotten their old one. If the system determines the user wants to edit the forgot password message, then the edit password message screen is displayed and the user can edit the password message, Step 734. If the system determines the user does not want to edit the forgot password message, then the system determines if the user wants to edit the administrative message to users of the system, Step 736.

The administrative message is used to alter users of new updates to the system, special events regarding the system, or any other messages an administrator may want to send to all the users of the system. If the system determines the user wants to edit the administrative message, then the system displays the edit administrative message screen, were the user an edit the administrative message, Step 738.

If the system determines that the user does not want to edit the administrative message, then the system determines if the user wants to edit when accounts expire or the expired account message that is sent to a user when their account expires or is about to expire, Step 740. If the system determines the user wants to edit when accounts expire or the expired account message, the system displays the expire account screen where the user can edit when accounts expire and/or the expire account message, Step 742.

If the system determines that the user does not want to edit when accounts expire or the expired account message, then the system determines if the user wants to quit or exit the system, Step 120. If the system determines that the user wants to quit, then the system ends the session, Step 122. If the system determines that the user does not want to quit, then the system determines if the user wants to view an organizer, Step 104.

It should be understood that the foregoing relates to exemplary embodiments of the invention and that modifications may be made without departing from the spirit and scope of the invention as set forth in the following claims.

What is claimed is:

1. A method for creating on online organizer, the method comprising the steps of:
logging onto a system where a electronic organizer will be stored;
naming the organizer;
creating at least two columns whereby the steps used to create each of the at least two columns include:
naming the column;
selecting the type of data used in the column;
setting the display order of the column; and
storing the organizer.

2. The method of claim 1 wherein the selected data type is text, memo, date/time, true/false, hyperlink, e-mail link, phone number, or file link.

3. The method of claim 1 further comprising the step of deleting a column.

4. The method of claim 1 further comprising the step of renaming a column.

5. The method of claim 1 further comprising the step of resetting the display order of the at least two columns.

6. The method of claim 1 further comprising the step of entering data into each of the at least two columns.

7. The method of claim 1 further comprising the step of setting a reminder wherein the step of stetting a reminder includes determining who will receive a reminder notice wherein upon activation of the reminder, an e-mail is sent to those who were determined to receive a reminder notice.

8. The method of claim 1 further comprising the step of sharing the organizer.

9. The method of claim 8 wherein the organizer is shared with a pre-selected group of users of the system.

10. The method of claim 8 wherein the organizer is shared with all users of the system.

11. The method of claim 1 wherein the organizer is created using a template.

12. A method for using an online organizer, the method comprising the steps of:
accessing a system where an electronic organizer is stored;
viewing at least one column in the organizer; and
changing at least one column whereby the change is renaming the column, changing type of data used in the column, or resetting the order of the column within the organizer.

13. The method of claim 11 wherein the selected data type is text, memo, date/time, true/false, hyperlink, e-mail link, phone number, or file link.

14. The method of claim 11 further comprising the step of setting a reminder wherein the step of stetting a reminder includes determining who will receive a reminder notice wherein upon activation of the reminder, an e-mail is sent to those who were determined to receive a reminder notice.

15. The method of claim 11 further comprising the step of editing record data in at least one column.

16. The method of claim 11 further comprising changing the organizer that is displayed when the system is accessed.

17. The method of claim 11 further comprising the step of sharing the organizer.

18. The method of claim 16 wherein the organizer is shared with a pre-selected group of users of the system.

19. The method of claim 16 wherein the organizer is shared with all users of the system.

20. An online organizer comprising:
means for accessing a system where an electronic organizer is stored;
means for viewing at least one column in the organizer; and
means for changing at least one column whereby the change is renaming the column, changing type of data used in the column, or resetting the order of the column within the organizer.
